(19) United States
(12) Patent Application Publication
(10) Pub. No.: US 2022/0389605 A1
(43) Pub. Date: Dec. 8, 2022

(54) BULK FINISHING SYSTEM AND METHOD

(71) Applicant: SST Systems, Inc., Sturgeon Bay, WI (US)

(72) Inventors: Chad Martin Andreae, Sturgeon Bay, WI (US); Robert G. Rock, Sturgeon Bay, WI (US)

(21) Appl. No.: 17/832,011

(22) Filed: Jun. 3, 2022

Related U.S. Application Data
(60) Provisional application No. 63/197,108, filed on Jun. 4, 2021.

(51) Int. Cl. C25D 17/28; C25D 13/22; C25D 17/02; B65G 49/02; B65G 54/02

(52) U.S. Cl. CPC C25D 17/28; C25D 13/22; C25D 17/02; B65G 49/02; B65G 54/02; B65G 2201/04

(57) ABSTRACT

A bulk finishing system including a plurality of liquid immersion workstations defining a finishing process for a plurality of metal work pieces processed therethrough. Each of the plurality of liquid immersion workstations includes a tank, and the plurality of metal work pieces are conveyed through a group of one or more of the respective tanks of the plurality of liquid immersion workstations by non-contact magnetic conveyance provided by an inclined downstream tank end wall forming a work piece exit slide, with a magnetic conveyor extending along an exterior side of the inclined downstream tank end wall. The plurality of work pieces are introduced loosely in bulk to each one of the group of tanks of the plurality of liquid immersion workstations.

### CROSS-REFERENCE TO RELATED APPLICATIONS

This application claims priority to co-pending U.S. Provisional Patent Application No. 63/197,108, filed Jun. 4, 2021, the entire contents of which are incorporated by reference herein.

### BACKGROUND

The present invention relates to systems for applying a finish to work pieces, for example metal work pieces. Some aspects of the invention relate to e-coating manufactured metal work pieces by immersion into a bath with charged paint particles. In the interests of capacity and efficiency, such systems may operate with baskets or cages full of small work pieces for coating. Each basket is attached to an indexing conveyor to transport the work pieces between tanks and to dip the work pieces into each tank. Once the process is completed, the coated work pieces are unloaded from the baskets. In other systems, individual parts are attached to the conveyor at a loading zone and subsequently detached from the conveyor following completion of the finishing process.

### SUMMARY

In one aspect, the invention provides a bulk finishing system including a plurality of liquid immersion workstations defining a finishing process for a plurality of metal work pieces processed therethrough. Each of the plurality of liquid immersion workstations includes a tank, and the plurality of metal work pieces are conveyed through a group of one or more of the respective tanks of the plurality of liquid immersion workstations by non-contact magnetic conveyance provided by an inclined downstream tank end wall forming a work piece exit slide, with a magnetic conveyor extending along an exterior side of the inclined downstream tank end wall. The plurality of work pieces are introduced loosely in bulk to each one of the group of tanks of the plurality of liquid immersion workstations.

In another aspect, the invention provides a bulk e-coat system with a plurality of liquid immersion workstations defining a single complete e-coat process. The workstations include at least one pre-treatment workstation with a tank, an e-coat bath workstation with a tank, and at least one post-rinse workstation with a tank. A pair of electrodes are arranged in the tank of the e-coat bath workstation, a first of the pair of electrodes configured to provide a slide along which work pieces are conveyed, and a second of the pair of electrodes positioned in an e-coat process liquid spaced from the slide. A curing workstation is provided in a downstream direction from the plurality of liquid immersion workstations and configured to receive the plurality of work pieces exiting a final one of the plurality of liquid immersion workstations. A plurality of magnetic conveyors are configured to run upward along respective inclined downstream end walls of the respective tanks of the plurality of liquid immersion workstations. Throughout the plurality of liquid immersion workstations and into the curing workstation, the work pieces are conveyed solely by the plurality of magnetic conveyors, without any conveyor passing over or through the respective tanks of the plurality of liquid immersion workstations.

In yet another aspect, the invention provides a method of carrying out a finishing process on a plurality of work pieces. A plurality of liquid immersion workstations are provided, each having a liquid immersion tank associated with the finishing process. A plurality of work pieces are provided in loose bulk form into a tank of one of the plurality of liquid immersion workstations. The plurality of work pieces are conveyed along a work piece slide at an inclined downstream end wall of the tank with a magnetic conveyor extending along an exterior side of the inclined downstream end wall. The plurality of work pieces are dumped in loose bulk form from the tank at a top outlet end of the work piece slide.

Other aspects of the invention will become apparent by consideration of the detailed description and accompanying drawings.

### BRIEF DESCRIPTION OF THE DRAWINGS

FIG. 1A is a side elevation view of an upstream portion of a coating system according to one aspect of the invention.

FIG. 1B is a side elevation view of a downstream portion of the coating system of FIG. 1A.

FIG. 2 is a cross-section view through one liquid immersion workstation of the coating system, taken along line 2-2 of FIG. 1A.

### DETAILED DESCRIPTION

Before any embodiments of the invention are explained in detail, it is to be understood that the invention is not limited in its application to the details of construction and the arrangement of components set forth in the following description or illustrated in the accompanying drawings. The invention is capable of other embodiments and of being practiced or of being carried out in various ways.

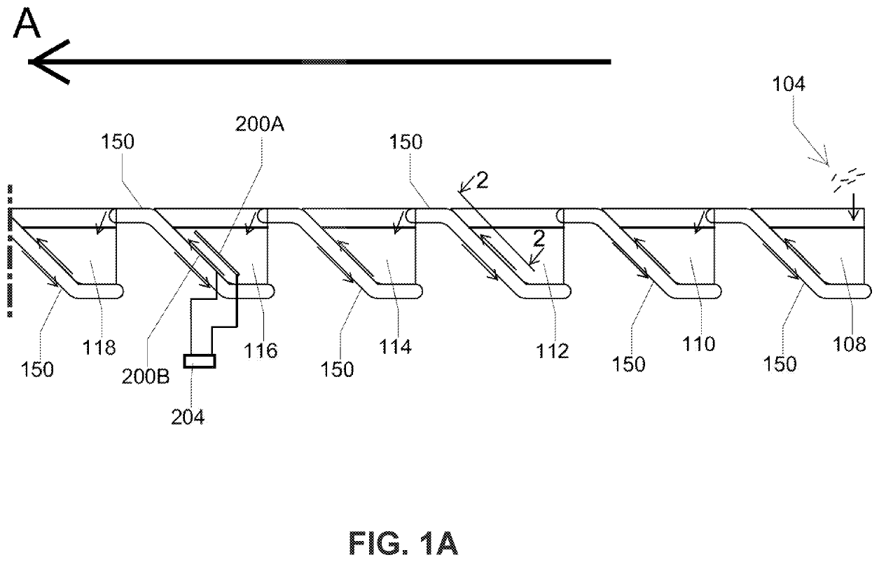

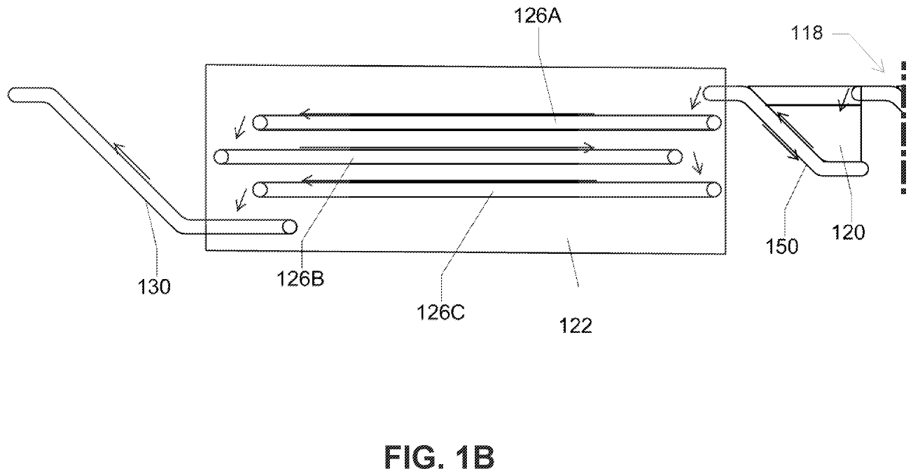

FIGS. 1A and 1B illustrate an industrial finishing system 100 for processing objects or work pieces 104 through a plurality of sequential workstations 108 to 122. The workstations 108 to 122 are arranged in a row and the process flow is from right to left as indicated by arrow A. The work pieces 104 can be unfinished manufactured articles, for example cast and/or machined metal items (e.g., steel). It should be appreciated that the work pieces 104 can be fasteners, hose clamps, clips, clasps, brackets (as a small sample set of small items that are manufactured, and sometimes also packaged and sold, in bulk), and the work pieces 104 need not have a particular shape or style. The system 100 can process a sequence of identical copies of the same work piece 104, simple variations thereof, or entirely different work pieces, one after the next. No engagement structure or positive physical attachment is provided for material handling purposes. Rather, the system 100 handles the work pieces 104 loosely in “bulk” fashion throughout some or all parts of the process, which greatly reduces time and effort normally associated with loading and unloading to and from the system 100 and also negates the need for specific structures that hold and carry the work pieces 104 through the multiple workstations 108 to 122. Work piece racks, baskets, etc. typically require maintenance after use, such as cleaning to maintain proper performance, and this effort is alleviated by the system 100.

In some constructions, the finishing process provided by the system 100 is a coating process configured to apply a finish coating (e.g., paint) to the work pieces. Other than finish coating, the work pieces may be complete, fully-formed and/or manufactured articles. The system 100 includes a series of sequential workstations 108 to 120 that define a single coating process that is complete up to the point of coating curing. Each of the workstations 108 to 120 can be liquid immersion workstations provided with a liquid immersion tank into which the work pieces 104 are passed. Exemplary liquid levels are shown. In some constructions, some or all of the tanks have pumps, agitators, fill/drain ports, etc. The coating process can be an e-coat process, also known as electrophoretic painting or electropainting. In the e-coat process, the work piece is first prepared for painting and then immersed into a water bath containing resin with or without pigments, and any desired additives. In one particular example, the workstations are as follows: 108) clean; 110) rinse; 112) conversion coat; 114) rinse; 116) e-coat application; 118) post rinse #1; and 120) post rinse #2. Multiple workstations (e.g., the first four 108, 110, 112, 114) collectively make up a surface pre-treatment phase or portion of the coating process. The e-coat application onto the surfaces of the work pieces 104 can take place in a single workstation 116. In the e-coat application workstation 116, opposite electrical charge is provided between the bath and the work piece 104 to promote adhesion of the paint particles onto the work piece, promoting uniform, complete coverage. The voltage potential is provided by a pair of opposite electrodes 200A, 200B. The electrodes 200A, 200B can be coupled to positive and negative poles of a DC rectifier 204 as schematically shown in FIG. 1A. The electrodes 200A, 200B can be bare or flushable in accordance with the particular coating type.

The system 100 additionally provides a curing workstation 122 (or “oven”) downstream of the final liquid immersion workstation 120 (e.g., final post rinse) through which work pieces 104 are processed. The oven 122 defines an internal oven chamber heated to a cure temperature (e.g., in excess of 300 degrees Fahrenheit) and configured to maintain residency of the work pieces 104 for a predetermined cure cycle time that hardens the coating applied to the work pieces 104 by the coating process just prior. In order to reduce overall footprint or process length, the oven 122 can include multiple conveyors 126A, 126B, 126C (e.g., three) that are vertically offset from one another. In the illustrated example, a first conveyor 126A of the oven 122 is an uppermost conveyor configured to first receive the work pieces 104 from the final liquid immersion workstation 120. This first conveyor 126A continues moving the work pieces 104 in the same downstream direction A as the work pieces 104 are conveyed through the prior workstations 108 to 120. The second conveyor 126B has an extended portion that runs beyond a downstream-most end of the first conveyor 126A. Thus, the work pieces 104 can fall off the end of the first conveyor 126A onto the second conveyor 126B, which can run opposite to the direction A, back toward the final liquid immersion workstation 120. A similar arrangement exists, and a similar transfer takes place between the second conveyor 126B and the third conveyor 126C, with the third conveyor 126C running back in the original direction A. In the instance where the third conveyor 126C is the final conveyor through the oven 122, the third conveyor 126C can be configured to drop the work pieces 104 onto an outlet conveyor 130. As illustrated, the outlet conveyor 130 escalates the work pieces 104 up an incline path. Other configurations, with or without an incline are optional, and in some constructions, the final oven conveyor 126C may extend out of the oven 122 to further convey the work pieces 104.

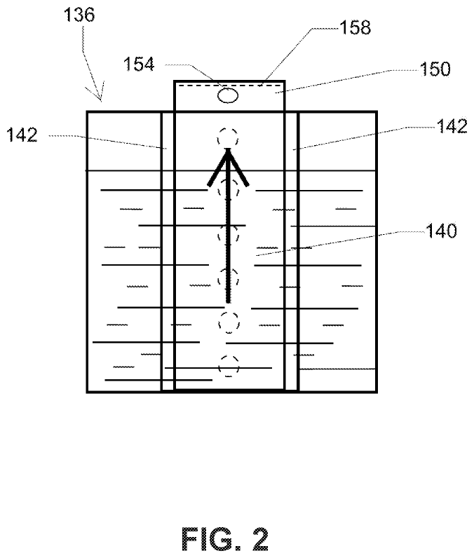

FIG. 2 depicts an inclined downstream end wall 136 of the tank of one of the workstations 112, representative of each one of the tanks for the workstations 108 to 120. The wall 136, along with the other remaining tank walls are configured to retain the process liquid. Although the tank can be constructed of a plurality of different types of material, for example aluminum sheet, a designated portion of the downstream end wall 136 can be separately constructed to form a runway slide 140 or simply “slide.” In some constructions, the slide 140 is manufactured from a more wear resistant material, such as stainless steel, as compared to the rest of the tank. As described further below, the slide 140 forms a wear surface along which the work pieces 104 are slid or dragged. The slide 140 can be removable from the tank and replaceable so as to allow the tank to otherwise not be subjected to substantial wear from the conveyance of the work pieces 104. The slide 140 can include or be flanked by raised sidewalls 142 to ensure guidance of the work pieces 104 along the slide 140.

For at least the e-coat workstation 116, the tank walls are non-conductive electrically so that the targeted voltage can be maintained between the electrodes 200A, 200B, between which the work pieces 104 are conveyed through the process liquid for coating. In particular, the tank of the e-coat workstation 116 has walls constructed of a non-conductive base material or alternately constructed of a conductive base material that is coated with a dielectric coating to be rendered non-conducting. The first electrode 200A can run parallel to the surface of the slide 140 at a predetermined offset that allows clearance for the conveyed work pieces 104. The second electrode 200B can be provided in whole or in part by the slide 140 in the e-coat tank 116, the work pieces 104 maintaining contact with the slide 140 and sharing the relative electric charge (ground (−) side) thereof. Therefore, the slide 140 is constructed of an electrically conductive material.

Running below and along the inclined wall 136 of each process tank is a magnet conveyor 150. The magnet conveyor 150 operates to make a loop, part of which extends just to the exterior side of the inclined wall 136 and the slide 140. The magnet conveyor 150 can run entirely on an outside of the tank. In other constructions, all or a portion of the magnet conveyor 150 can extend within the liquid tank volume and may be exposed to the process liquid. The magnet conveyor 150 includes a plurality of spaced magnets 154 (e.g., permanent magnets) as shown in FIG. 2, the magnets 154 configured to attract the work pieces 104 (e.g., ferromagnetic work pieces). The magnets 154 can be bonded to, fastened to, or embedded in an endless conveyor belt that is engaged by a drive (not shown). The magnet conveyor 150 in each tank runs from a tank bottom wall, up the inclined wall 136 and out of the liquid bath toward a next workstation. The magnet conveyor 150 can release the work pieces 104 into the next workstation. For example, the work pieces 104 can fall by gravity after being pulled off the magnet 154 by a scraper 158 positioned at the designated release point, or alternately after a magnetic field of the magnet 154 is turned off in the case of a controlled electromagnet.

To begin operation of the process carried out by the system 100, the work pieces 104 are supplied in bulk and thus, there is no discrete loading of the work pieces 104. In particular, the work pieces 104 are not coupled, directly or indirectly, to a conveyor for entry to the first workstation 108. The work pieces 104 can be dumped in a controlled manner, for example with a predetermined batch size or a predetermined pour rate, into the process tank of the first workstation 108. The work pieces 104 settle to the bottom wall or floor of the tank where they become attracted to one of the magnets 154 of the magnet conveyor 150. Once attracted to a magnet 154, each work piece 104 begins to travel in sync with the movement of the magnet 154 by sliding movement along the slide 140. The work pieces 104 continue to be exposed to the process liquid as they are conveyed up the incline of the wall 136 toward the top of the tank for exit and transfer to the next workstation 110. The work pieces 104 are disengaged from the magnet conveyor 150 according to the above description and fall into the second workstation 110 for a similar conveyance through the second process liquid. The process is carried out repeatedly for each one of the liquid immersion workstations 108 to 120. At the e-coat workstation 116, the work pieces 104 are additionally exposed to the charged process liquid with the coating particles. The electrodes 200A, 200B maintain the prescribed voltage, and as the work pieces 104 are passed between the electrodes 200A, 200B by the magnet conveyor 150, the coating particles come out of solution to electrically bond onto the work pieces 104. As mentioned above, the slide 140 acts as the second electrode 200B, maintaining contact with the work pieces 104 as they pass under the first electrode 200A. The coating particles can have a first charge (e.g., positive) imparted by the first electrode 200A and attracted to the oppositely charged (e.g., grounded) work pieces 104.

Although individual magnets 154 of a given magnet conveyor 150 can and should maintain hold of a work piece 104 through a given workstation, there is no assurance of any one work piece 104 being associated with any one given magnet 154, the association being effectively randomized due to the bulk material handling that takes place. The bulk nature of the handling of the work pieces 104 continues in the transfer among the liquid immersion workstations 108 to 120. Effectively, the work pieces 104 are dumped from one tank to the next, in contrast to one or more conveyors that maintain custody or at least specific order of the work pieces 104 throughout the workstations. Similar loose dump transfers take place from the final liquid immersion workstation 120 to the oven 122 and again within the oven 122. The exit conveyor 130 can dump the coated work pieces 104 directly into a product package or may deliver the coated work pieces 104 to a product packaging workstation. In other constructions, the coated work pieces 104 may be collected for further processing or conveyance, for example to an additional manufacturing process or point of use.

The system 100 can be considered “conveyorless” in that there is no overhead conveyor spanning the workstations 108 to 122 to convey the work pieces 104. Although magnet conveyors 150 can be utilized in accordance with the preceding description, the system 100 lacks any single conveyor that retains and transports the work pieces 104 through the sequential liquid immersion workstations 108 to 120, the work pieces 104 instead being dumped into each tank of these workstations. In the illustrated embodiment, the work pieces 104 are also dumped rather than carried or conveyed into the oven 122 that cures the coating. Due to these features, the system 100 can run continuously with non-stop operation or movement for extended periods of time, greater than one full cycle time, since there is no primary or overall conveyor requiring stoppages for loading and unloading at the respective ends.

Although described and shown with respect to an e-coat process, aspects of the invention can apply to other types of finishing systems and processes. For example, the workstations may prepare and/or apply a plating onto the work pieces 104, or the work pieces 104 may be subjected to a dip and spin painting process. Aspects of the bulk handling and conveyance of the work pieces 104 may be carried out similar to the preceding description. In some aspects, the system may be modified to utilize non-contact magnetic conveyance in only a select group of one or more of the respective tanks. This may be true of an e-coat process or an alternate finishing process. For example, non-contact magnetic conveyance may be used in some or all of the pre-treatment tanks (e.g., workstations 108, 110, 112, 114) leading up to a finish application workstation (e.g., e-coat workstation 116). The work pieces 104 can be loaded into a basket or onto a conveyor belt for passage through the e-coat bath or other finish-applying bath. The system can be selectively or locally conveyorized, e.g., with a conveyor system that only spans part of the process, the work pieces 104 being handled by the workstation-dedicated magnet conveyors 150 elsewhere. The work pieces 104 are either grouped into a permeable basket and dipped (e.g., by an overhead conveyor) into the finish-applying bath or placed onto a conveyor belt that runs through the finish-applying bath. If used, a conveyor belt can be a magnetic belt or non-magnetic belt that retains the work pieces 104 by friction. The conveyor may have a less steep incline than shown in the illustrated embodiment. With a basket or a belt, the work pieces 104 may be moved by a conveyor, without sliding or dragging along a surface. From the finish application, the work pieces 104 can either be maintained in the same basket (or on the same conveyor) for further passage through additional workstations, or may be dumped loosely into a following workstation (e.g., the tank of first post-rinse workstation 118) to be moved through the remainder of the process according to the preceding description.

Various features and advantages of the invention are set forth in the following claims.

What is claimed is:

1. A bulk finishing system comprising:
a plurality of liquid immersion workstations defining a finishing process for a plurality of metal work pieces processed therethrough,
wherein each of the plurality of liquid immersion workstations includes a tank, and the plurality of metal work pieces are conveyed through a group of one or more of the respective tanks of the plurality of liquid immersion workstations by non-contact magnetic conveyance provided by an inclined downstream tank end wall forming a work piece slide, with a magnetic conveyor extending along an exterior side of the inclined downstream tank end wall, and wherein the plurality of work pieces are introduced loosely in bulk to each one of the group of tanks of the plurality of liquid immersion workstations.

2. The bulk finishing system of claim 1, wherein the plurality of liquid immersion workstations define an e-coat process including a charged e-coat bath workstation having a pair of oppositely charged electrodes, one of which forms the work piece slide.

3. The bulk finishing system of claim 2, wherein in the e-coat process, the plurality of liquid immersion workstations includes, in order: clean, rinse, conversion coat, rinse, e-coat, and post rinse workstations.

4. The bulk finishing system of claim 1, wherein the plurality of liquid immersion workstations define an e-coat process including a charged e-coat bath workstation, and wherein the bulk finishing system comprises a basket or belt for conveying the plurality of metal work pieces through the charged e-coat bath workstation such that the group of tanks having non-contact magnetic conveyance does not include a tank of the charged e-coat bath workstation.

5. The bulk finishing system of claim 1, further comprising a curing workstation including an oven chamber configured to cure a coating on the plurality of work pieces resulting from the plurality of liquid immersion workstations defining the finishing process, wherein the curing workstation includes at least a first conveyor and a second conveyor positioned below the first conveyor and configured to receive loose work pieces dropped from the end of the first conveyor.

6. The bulk finishing system of claim 1, wherein the magnetic conveyor includes a plurality of permanent magnets.

7. The bulk finishing system of claim 1, wherein the magnetic conveyor includes a plurality of electromagnets.

8. The bulk finishing system of claim 1, wherein work piece slide includes or is flanked by raised sidewalls configured to maintain the work pieces therebetween.

9. The bulk finishing system of claim 1, wherein the work piece slide is constructed of a material having higher wear resistance than the remainder of the tank.

10. The bulk finishing system of claim 1, wherein the work piece slide is configured as a removable portion of the tank.

11. A bulk e-coat system comprising:
a plurality of liquid immersion workstations defining a single complete e-coat process, including at least one pre-treatment workstation with a tank, an e-coat bath workstation with a tank, and at least one post-rinse workstation with a tank;
a pair of electrodes arranged in the tank of the e-coat bath workstation, a first of the pair of electrodes configured to provide a slide along which work pieces are conveyed, and a second of the pair of electrodes positioned in an e-coat process liquid spaced from the slide;
a curing workstation provided in a downstream direction from the plurality of liquid immersion workstations and configured to receive the plurality of work pieces exiting a final one of the plurality of liquid immersion workstations; and
a plurality of magnetic conveyors configured to run upward along respective inclined downstream end walls of the respective tanks of the plurality of liquid immersion workstations, wherein, throughout the plurality of liquid immersion workstations and into the curing workstation, the work pieces are conveyed solely by the plurality of magnetic conveyors, without any conveyor passing over or through the respective tanks of the plurality of liquid immersion workstations.

12. The bulk e-coat system of claim 11, wherein the slide is removable from a set of non-conducting tank walls to be separately replaceable.

13. The bulk e-coat system of claim 12, wherein the slide is constructed of a material having higher wear resistance than the set of non-conducting tank walls.

14. The bulk e-coat system of claim 11, wherein in the tank of the e-coat bath workstation, the slide includes or is flanked by raised sidewalls configured to maintain the work pieces therebetween.

15. The bulk e-coat system of claim 11, wherein each of the plurality of magnetic conveyors includes a plurality of permanent magnets.

16. The bulk e-coat system of claim 11, wherein each of the plurality of magnetic conveyors includes a plurality of electromagnets.

17. The bulk e-coat system of claim 11, wherein the plurality of liquid immersion workstations defining the e-coat process includes, in order: clean, rinse, conversion coat, rinse, e-coat, and post rinse workstations.

18. The bulk e-coat system of claim 11, wherein the curing workstation includes at least a first conveyor and a second conveyor positioned below the first conveyor and configured to receive loose work pieces dropped from the end of the first conveyor.

19. A method of carrying out a finishing process on a plurality of work pieces, the method comprising:
providing a plurality of liquid immersion workstations, each having a liquid immersion tank associated with the finishing process;
providing a plurality of work pieces in loose bulk form into a tank of one of the plurality of liquid immersion workstations;
conveying the plurality of work pieces along a work piece slide at an inclined downstream end wall of the tank with a magnetic conveyor extending along an exterior side of the inclined downstream end wall; and
dumping the plurality of work pieces in loose bulk form from the tank at a top outlet end of the work piece slide.

20. The method of claim 19, further comprising receiving, in loose bulk form, the plurality of work pieces into a curing workstation from a final one of the plurality of liquid immersion workstations.

21. The method of claim 19, wherein the finishing process is an e-coat process by which the plurality of work pieces are coated with paint at the tank having the work piece slide, the method further comprising:
at an e-coat bath workstation of the plurality of workstations, charging the work piece slide to act as one of a pair of oppositely-charged electrodes;
providing the other of the pair of oppositely-charged electrodes at an offset that provides clearance for the plurality of work pieces on the slide; and
utilizing charged attraction to drive coating particles out of a solution in a coating bath of the e-coat bath workstation onto the plurality of work pieces being conveyed along the work piece slide.

22. The method of claim 19, further comprising dislodging one of the plurality of work pieces from a permanent magnet of the magnetic conveyor with a scraper the top outlet end of the work piece slide.

23. The method of claim 19, further comprising releasing one of the plurality of work pieces from an electromagnet of the magnetic conveyor by depowering the electromagnet at the top outlet end of the work piece slide.
